(19) United States
(12) Patent Application Publication
(10) Pub. No.: US 2025/0197107 A1
(43) Pub. Date: Jun. 19, 2025

(54) CONVEYING DEVICE AND RACK STORE

(71) Applicant: LTW Intralogistics GmbH, Wolfurt (AT)

(72) Inventors: Bernhard PETER, Krumbach (AT); Rainer SOHM, Dornbirn (AT)

(73) Assignee: LTW Intralogistics GmbH, Wolfurt (AT)

(21) Appl. No.: 19/071,436

(22) Filed: Mar. 5, 2025

Related U.S. Application Data
(63) Continuation of application No. PCT/EP2023/074013, filed on Sep. 1, 2023.

(30) Foreign Application Priority Data
Sep. 5, 2022 (DE) 10 2022 122 380.9

(51) Int. Cl. B65G 1/04

(52) U.S. Cl. CPC B65G 1/0407; B65G 1/0442

(57) ABSTRACT

A conveying device comprising a chassis with a drive unit which is set up to move the conveying device in and against a direction of travel along storage locations at least in sections parallel to or along a horizontal plane. At least one load-handling device is set up to introduce a stored item into one of the storage locations or to discharge it from one of the storage locations. The load-handling device is arranged to introduce the stored goods into one of the storage locations parallel to or along the horizontal plane at an angle (α) with respect to the direction of travel, or to discharge them from one of the storage locations, which angle (α) differs from a 90-degree angle. A high-bay warehouse with such a stacker crane is also provided.

This nonprovisional application is a continuation of International Application No. PCT/EP2023/074013, which was filed on Sep. 1, 2023, and which claims priority to German Patent Application No. 10 2022 122 380.9, which was filed in Germany on Sep. 5, 2022, and which are both herein incorporated by reference.

### BACKGROUND OF THE INVENTION

### Field of the Invention

The invention relates to a conveying device, in particular a conveying device for storing a stored item in a storage bin and/or for removing a stored item from a storage bin. The conveying device comprises a chassis with a drive unit moving the conveying device in and against a direction of travel along the storage bins. The conveying device is moved at least in sections parallel to a horizontal plane or in sections along a horizontal plane. For moving the stored goods, the conveying device comprises at least one load-handling device, which is set up to bring a stored good into one of the storage locations or to remove it from one of the storage locations. The invention also relates to a rack storage system for storing such stored goods

### Description of the Background Art

The stored goods are preferably piece goods, which are in particular provided with a loading aid, for example a pallet or similar.

However, it has been found that some stored goods are particularly long, meaning that they cannot be stored or retrieved fully automatically in the storage spaces of existing storage areas or warehouses; these stored goods require a great deal of space for handling. This is particularly the case when storing containers or even entire trucks.

### SUMMARY OF THE INVENTION

It is therefore an object of the present invention to provide a conveying device and a rack storage system with which particularly long stored goods can be efficiently stored or retrieved.

The conveying device according to an example of the invention comprises a chassis with a drive unit which is set up to move the conveying device in and against a direction of travel along storage locations at least in sections parallel to or along a horizontal plane. The conveying device also comprises at least one load-handling device, which is set up to bring a stored item into one of the storage locations or to remove it from one of the storage locations. This load-handling device is set up to bring the stored goods into one of the storage bins parallel to or along the horizontal plane at an angle a with respect to the direction of travel or to remove them from one of the storage bins, the angle a being different from a 90-degree angle. Preferably, however, the angle a also differs from any integer multiple of a 90-degree angle.

An advantage of this conveying device is that longer goods can be stored in existing buildings with fixed dimensions. In order to bring the longer goods into the building, less space is also required outside the building for feeding the stored goods. This is particularly useful in congested areas where there is not so much space or free space available. This is because more space is required around the building for long goods that are to be placed vertically in a storage building than is the case if-which corresponds to one of the basic ideas of the present invention-the stored goods are placed in the building at a “shallower” angle. A smaller number of storage locations can be accepted.

It has proven to be advantageous if the angle a is between 45 degrees and 80 degrees. In this range, the space available in an existing warehouse building is used sensibly. In order to be able to store long containers (e.g. 40-foot containers or 20-foot containers), it has proven to be preferable if the angle a is between 60 degrees and 75 degrees. Preferably, the angle a is approximately 70 degrees, whereby this angular position with regard to the direction of travel of the conveying device has proven to be advantageous because not only containers, but also entire trucks can then be brought into the storage bins or removed from one of the storage bins.

The floor plan of the conveying device, i.e. its chassis, in particular its chassis frame, can be formed with any cross-section. The drive frame can be diamond-shaped or even rectangular, for example, as long as it is ensured that the storage and retrieval of the stored goods in one of the storage compartments can take place at an angle a with respect to the direction of travel of the conveying device, which is different from a 90-degree angle and any integer multiple of a 90-degree angle. The angle a should also be an angle other than zero degrees.

As the goods to be stored or retrieved are heavy goods, it has proven to be advantageous if the chassis of the conveying device comprises, for example, at least four wheels and if the four wheels span a parallelogram, which is different from a rectangle. This design allows the stored goods to be reliably moved into or out of the storage bins.

In this context, it has also proven advantageous if the chassis comprises a drive frame, and if the drive frame essentially spans a parallelogram, which is different from a rectangle. This design also gives the conveying device greater stability, so that heavy loads, such as containers or entire trucks, can be brought into or taken out of the storage bins safely.

The parallelogram may also differ from a rhombus, with the load-handling device executing a travel path that is aligned parallel to the long edges of the parallelogram during storage operations or during retrieval operations. In this way, the conveying device itself also requires very little space and can bring long goods into the storage bins or remove them from the storage bins in a particularly simple manner.

If the parallelogram also differs from a rhombus, it may be advantageous, depending on the dimensions of the stored goods to be stored, if the load-handling device performs a travel path that is aligned parallel to the short edges of the parallelogram during storage or retrieval operations.

In order to correctly align the stored goods to be brought into or removed from the storage bins, the load-handling device can be mounted on a rotating device that can be rotated between at least two fixed rotational positions. For example, the rotation device can be rotated between a fixed first rotational position, in which a stored item can be transferred to the load-handling device for storage or in which a stored item can be dispensed from the load-handling device for retrieval, and a second rotational position corresponding to the angle a, in which the load-handling device can bring a stored item into one of the storage locations or remove it from one of the storage locations. It is also possible for the rotation device to assume more than two fixed rotational positions, which is particularly useful if not all storage locations are aligned parallel to each other.

In order to design the conveying device with a lower degree of complexity, the load-handling device can be mounted in a rotationally fixed position at the angle a with respect to the direction of travel of the conveying device. In this way, the number of moving parts for the storage operations is reduced, which also minimizes the weight of the conveying device.

It is expedient if the conveying device also comprises a lifting unit which can be adjusted vertically with respect to the direction of travel in and against a lifting direction. The load-handling device is picked up or can be picked up by the lifting unit, whereby the load-handling device can be set up to bring stored goods into one of the storage locations essentially perpendicular to the lifting direction or to remove them from one of the storage locations.

The lifting unit can be set up to move the load-handling device between different levels of a rack. In particular, the rack can be part of a high-bay warehouse, whereby a first level of the rack differs from a second level of the rack. In particular, the levels can be offset vertically in relation to each other. The levels can be aligned parallel to each other. The conveying device can also be equipped with the lifting unit for operating the different levels.

It is possible for the load-handling device to be formed as a vehicle which is set up to enter a storage channel from one of the storage bins or to leave a storage channel from one of the storage bins. In this way, the stored goods, for example the container or the truck, can be reliably brought into or removed from the storage location in question. It is possible for the load-handling device to be formed from a plurality of such vehicles, each of which transports a part of the stored goods and which can be moved synchronously with one another.

The vehicle then can comprise (vertically) adjustable lifting elements in a manner known per se in order to be able to lift stored goods, in particular unit loads, from a shelf compartment or lower them onto a shelf compartment. Furthermore, the stored goods can be picked up from or transferred to a transfer station by means of the lifting elements. The lifting elements can also be used to place the stored goods picked up by the conveying vehicle on the conveying device or on the lifting unit (lifting table) of the conveying device and pick them up again from there for storage operations.

The advantages and advantageous embodiments and effects mentioned in connection with the conveying device according to the invention apply in the same way to the rack storage system according to the invention, which is equipped with such a conveying device. The rack storage system comprises at least one rack which comprises a plurality of storage locations, wherein a rack aisle extends at least in sections along the rack, in which a conveying device formed as a stacker crane is present.

Very long goods can be stored in such a rack storage system due to the angular position of the rack locations, especially if the dimensions are already specified in the floor plan of the building or the available storage space outside buildings. In order to accommodate a large number of stored goods in the rack storage system, the storage locations are preferably arranged on different levels.

In particular, it is thus provided that the storage locations of the rack are aligned at an angle with respect to the direction of travel of the conveying device that differs from a 90-degree angle and an integer multiple of a 90-degree angle.

It is advantageously possible for the storage locations of a first level to be aligned at an angle with respect to the direction of travel of the conveying device that is different from a 90-degree angle and an integer multiple of a 90-degree angle, and for the storage locations of a second level to be aligned at a 90-degree angle with respect to the direction of travel of the conveying device, with the first level of the rack being different from the second level of the rack. The conveying device is then equipped with a lifting unit to operate the different levels. The lifting unit may comprise a rotation device to serve the differently aligned storage locations in the first level and in the second level. It is possible for the lifting unit not to have a rotating device, but for a rotating device to be present in the rack aisle in order to rotate the conveying device as a whole about a vertical plane so that the differently aligned storage locations can be served.

It has proven to be advantageous if the storage bins are designed in such a way that a load-handling device can be aligned with them in order to be able to bring a stored item into the storage bin or remove it from the storage bin. It is also advantageous if a load-handling device can enter the storage bins in alignment or leave these storage bins in alignment; for example, if the load-handling device is a vehicle or a shuttle.

In order to make sensible use of the available space, it is advantageous that the storage bins essentially form a parallelogram when viewed in the direction of fall, i.e. in plan, which is different from a rectangle.

Preferably, the two long edges or the two short edges of the parallelogram defined by the storage bins can be aligned parallel or substantially parallel to the two long edges of the parallelograms that are spanned by the wheels or the drive frame of the associated conveying device.

In addition, the travel path of the load-handling device can be aligned parallel or substantially parallel to one of the two long edges or substantially parallel to one of the two short edges of the parallelograms spanned by the storage bins in a plan view. This facilitates the storage or retrieval process for the stored goods.

It is possible for at least one transfer zone to be present, which extends through at least one of the shelves, in order to transfer a stored item to be stored to the conveying device for storage or to output a stored item to be retrieved from the conveying device for retrieval. In this way, the conveying device can serve shelves on both sides, with the stored goods being transferred through one of the two shelves. The transfer zone can be operated bidirectionally, so that both storage and retrieval of the stored goods takes place via this transfer zone.

It may also be advantageous for a good flow in the rack storage system if there is only a unidirectional transfer zone, whereby a first transfer zone is used to transfer a stored item to be stored to the conveying device for storage, and whereby a second transfer zone is used to take a stored item to be retrieved from the conveying device for retrieval and then to retrieve it.

For the storage of containers that are delivered or picked up by trucks, it has proven to be advantageous if a receiving area used for storage can be provided on a side of a first rack facing away from the rack aisle and if a dispensing area used for retrieval is provided on a side of a second rack facing away from the rack aisle, with the first rack and the second rack being arranged on both sides of the rack aisle and forming the rack aisle between them. In this way, on the one hand, only the supply of stored goods is present and, on the other hand, only the removal of stored goods takes place. If, on the other hand, entire trucks are stored, they can easily enter the rack storage system or its receiving area at a “flat” angle, which differs from a 90-degree angle and from an integer multiple of a 90-degree angle. The exit at the dispensing area also takes place at an angle that differs from a 90-degree angle and from an integer multiple of a 90-degree angle.

Further scope of applicability of the present invention will become apparent from the detailed description given hereinafter. However, it should be understood that the detailed description and specific examples, while indicating preferred embodiments of the invention, are given by way of illustration only, since various changes, combinations, and modifications within the spirit and scope of the invention will become apparent to those skilled in the art from this detailed description.

### BRIEF DESCRIPTION OF THE DRAWINGS

The present invention will become more fully understood from the detailed description given hereinbelow and the accompanying drawings which are given by way of illustration only, and thus, are not limitive of the present invention, and wherein:

FIG. 1 shows a schematic top view of a high-bay warehouse in the form of a high-bay warehouse with a conveying device, and

FIG. 2 shows a schematic side view of the conveying device in the rack aisle, with the dots outlined horizontally indicating the continuation of the rack, which has been hidden there for the sake of clarity.

### DETAILED DESCRIPTION

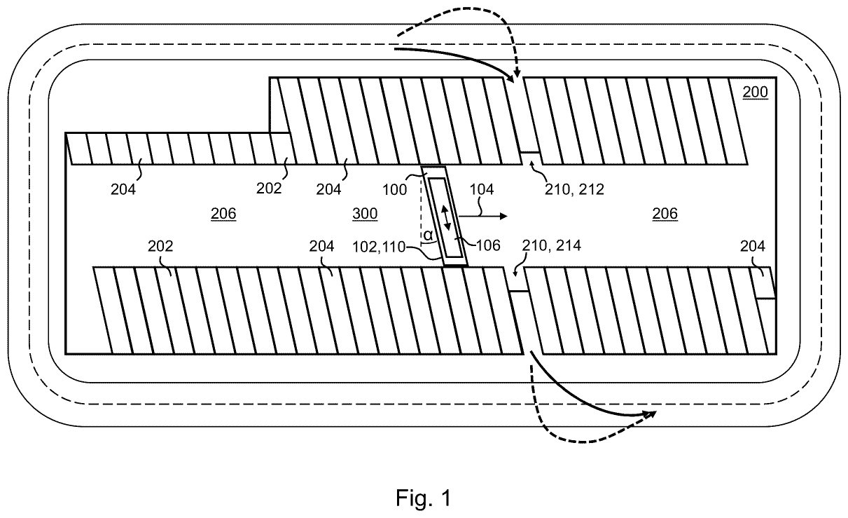

FIG. 1 illustrates a plan view of a high-bay warehouse 200 in the form of a high-bay warehouse. The rack storage system 200 comprises two rows of racks 202, each rack 202 comprising a plurality of storage locations 204 arranged at different levels. A rack aisle 206 extends along the racks 202, which in the present case is formed by the two rows of racks arranged at a distance from one another. In this rack aisle 206, a conveying device 100 formed as a stacker crane is shown, which comprises a chassis 102 with a drive unit, which are arranged to move the conveying device 100 in and against a direction of travel 104 along the storage locations 204 parallel to a horizontal plane 300 or along the horizontal plane 300.

The shelves 202 of the storage system 200 are arranged in a building that can be reached from a street by way of example only. It is not necessarily the case that a building envelope is present. Rather, the rack 202 or the entire rack storage system 200 can also be located outdoors. In order to bring stored goods into the warehouse, the rack storage system 200 has a receiving area 212 used for storage. This receiving area 212 is adjoined by a transfer zone 210 for transferring a stored item, for example a container or even an entire truck, to the stacker crane in the rack aisle 206.

It can be seen that the orientation of the racks 202 is inclined with respect to the rack aisle 206, which means that on the one hand a “flatter” angle than 90 degrees is required for the supply of the stored goods starting from the road, which is illustrated by the solid (upper) arrow. If the racks 202 were arranged vertically with respect to the building envelope, the long stored goods would have to be fed to the rack storage 200 beyond the opposite lane, which is illustrated by the dashed (upper) arrow.

The stored goods can be stored and retrieved via the same transfer zone 210 if this can be operated bidirectionally. If, on the other hand, the transfer zone 210 can be operated unidirectionally, there may be a dispensing area 214 used for retrieval, which is also assigned a transfer zone 210. A “flatter” retrieval of the stored goods, for example a “flatter” retrieval of a truck, is also possible at the dispensing area 214 due to the inclined arrangement of the shelves 202, as illustrated by the solid (lower) arrow. If the shelves 202 are not inclined at an angle a, a very large radius would have to be traveled again when extending them, as illustrated by the dotted line of the (lower) arrow. The inclined alignment can therefore be used to limit the area required around the building of the storage and retrieval system 200 for storage or retrieval. This is particularly advantageous in congested areas where there is no free space to move around.

In short, in the present case a receiving area 212 serving for storage is provided on a side of a shelf 202 facing away from the shelf aisle 206, wherein a dispensing area 214 serving for retrieval is provided on a side of a second shelf 202 facing away from the shelf aisle 206. The first shelf 202 and the second shelf 202 are spaced apart from each other and in this way define the shelf aisle 206, in which the conveying device 100 is located. It should be noted at this point that two of the conveying devices 100 or three of the conveying devices 100 may also be present in the rack aisle 206. In a further embodiment, more than three of the conveying devices 100 are present in the rack aisle 206.

In any case, each of the rack aisle 206 movable conveying devices 100 comprises a load-handling device 106 which is arranged to introduce the stored goods into one of the storage locations 204 or to discharge them from one of the storage locations 206 parallel to the horizontal plane 300 or along the horizontal plane 300 at an angle a with respect to the direction of travel 104. The non-zero angle a is different from a 90-degree angle and from any integral multiple of a 90-degree angle. This ensures that stored goods can be introduced into the storage rack 200 in a “flat” manner and that in particular, very long stored goods can be stored in a high-bay warehouse with existing dimensions due to their angular orientation in the rack 202.

The angle a is approximately 70 degrees in the present case. However, it is preferably in a range of 45 degrees to 80 degrees and depends in particular on the type of goods to be stored. The stored goods are preferably piece goods and can be provided in the present case, for example, on a pallet that can be placed in the storage locations 204. As can be from FIG. 1, the chassis 102 comprises a drive frame 110, wherein the drive frame 110 essentially spans a parallelogram, which differs from a rectangle and from a rhombus. The load-handling device 106 performs a travel path during storage operations or during retrieval operations, which in the present case is aligned parallel to the long edges of the parallelogram. The load-handling device 106 is mounted so that it cannot rotate at an angle a with respect to the direction of travel 104.

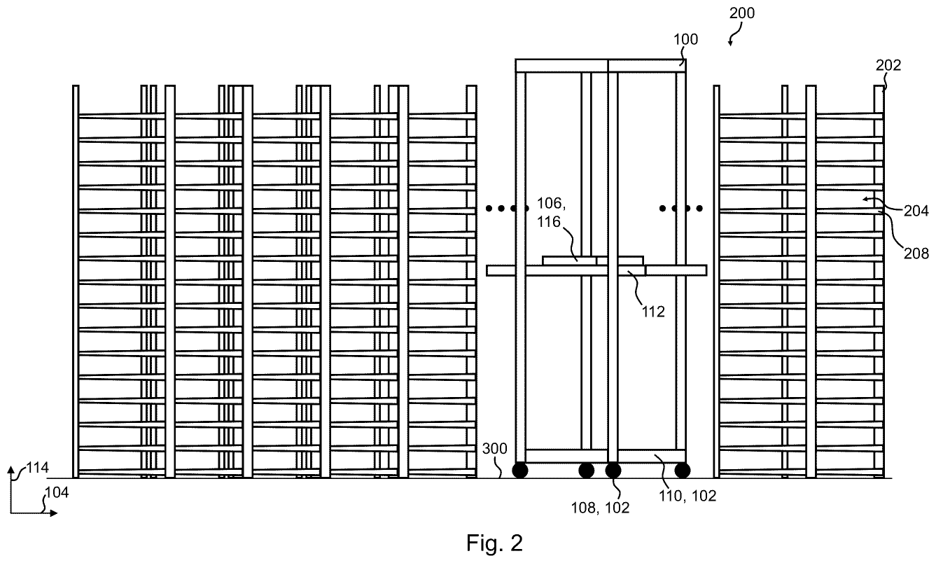

In FIG. 2 it can be seen that the chassis 102 comprises at least four wheels 108, which are movable in the rack aisle 206 on rails or without rails. These four wheels 108 also span a parallelogram between them, which differs from a rectangle and from a rhombus. It can be seen that the conveying device additionally comprises a lifting unit 112 which is adjustable vertically with respect to the direction of travel 104 in and against a lifting direction 114, the load-handling device 106 being received or receivable by the lifting unit 112. The load-handling device 106 is thereby arranged to bring stored goods into one of the storage locations 204 of the rack 202 substantially vertically with respect to the lifting direction 114 or to remove them from one of the storage locations 204 of the rack 202.

In the present case, the load-handling device 106 is designed such that it can itself move into the storage locations 204 or move out of the storage locations 204. The load-handling device 106 can, for example, be formed as a load fork. In the present case, however, a load-handling device 106 is used which is formed as a vehicle 116. The channel vehicle 116 is set up to enter a storage channel 208 of the storage bins 204 or to leave a storage channel 208 of the storage bins 204. It is possible for there to be space on the lifting unit 112 for several of the channel vehicles 116 and for these to also enter or leave the storage channels 208 synchronously. For this reason, the storage locations 204 are also designed in such a way that a load-handling device 106 can enter them in alignment or leave them in alignment.

Analogous to the design of the chassis frame 110 or the arrangement of the wheels 108, the storage locations 204 are also essentially formed in the shape of a parallelogram when viewed in the direction of fall, i.e. in plan view, which differs from a rectangle and, in the present case, also from a rhombus. In this way, particularly long goods can be stored in or removed from the shelves 202. In the present case, the two long edges of the parallelogram defined by the storage locations 204 are aligned parallel to the two long edges of the parallelograms, which are spanned by the arrangement of the wheels 108 or by the drive frame 110. The travel path of the load-handling device 106 is thereby aligned parallel to the two long edges of the parallelograms spanned by the storage locations 204.

In order to store a stored item in the rack storage 200, it is provided at the receiving area 212, which is located on a side of a first rack 202 facing away from the rack aisle 206. By means of the transfer zone 210 there, the stored goods are transferred to the load-handling device 106 of the conveying device 100. The conveying device 100 is then moved along the rack aisle 206 until it has reached the position in the warehouse at which the desired storage location 204 is located. If necessary, the lifting unit 112 is actuated at the same time or after the movement in order to assume the correct height position for storage before the stored goods are placed in the desired storage location 204 using the load-handling device 106. To remove a stored item from the rack storage 200, it is first removed from one of the storage locations 204. Then, the conveying device 100 is moved along the rack aisle 206 until it has reached the position in the warehouse at which it has reached the transfer zone 210 of the output area 214. If necessary, the lifting unit 112 is actuated at the same time or after the movement in order to assume the correct height position for the transfer zone 210 before the stored goods are transferred to the output area 214 in the transfer zone 210 using the load-handling device 106. The dispensing area 214 is presently provided on a side of a second shelf 202 facing away from the shelf aisle 206, wherein the first shelf 202 and the second shelf 202 are arranged on both sides of the shelf aisle 206 and form the shelf aisle 206 between them.

The invention being thus described, it will be obvious that the same may be varied in many ways. Such variations are not to be regarded as a departure from the spirit and scope of the invention, and all such modifications as would be obvious to one skilled in the art are to be included within the scope of the following claims.

What is claimed is:

1. A conveying device comprising:
a chassis with a drive unit that is set up to move the conveying device in and against a direction of travel along storage locations at least in sections substantially parallel to or along a horizontal plane; and
at least one load-handling device, which is set up to bring a stored item into one of the storage locations or to remove the stored item from one of the storage locations,
wherein the load-handling device is set up to introduce the stored goods into one of the storage locations substantially parallel to or along the horizontal plane at an angle (α) with respect to the direction of travel or to discharge them from one of the storage locations, and
wherein the angle (α) differs from a 90-degree angle.

2. The conveying device according to claim 1, wherein the angle is from 45 degrees to 80 degrees, from 60 degrees to 75 degrees, or about 70 degrees.

3. The conveying device according to claim 1, wherein the chassis comprises at least four wheels, and wherein the four wheels span a parallelogram between them, which differs from a rectangle.

4. The conveying device according to claim 1, wherein the chassis comprises a drive frame, and wherein the drive frame substantially spans a parallelogram, which is different from a rectangle.

5. The conveying device according to claim 3, wherein the parallelogram also differs from a rhombus, and wherein the load-handling device performs a travel path which is aligned parallel to the long edges of the parallelogram during storage operations or during retrieval operations.

6. The conveying device according to claim 3, wherein the parallelogram also differs from a rhombus, and wherein the load-handling device performs a travel path which is aligned parallel to the short edges of the parallelogram during storage operations or during retrieval operations.

7. The conveying device according to claim 1, wherein the load-handling device is mounted on a rotating device adapted to be rotated between a fixedly predetermined first rotational position in which a stored item is transferred to the load-handling device for storage or in which a stored item is discharged from the load-handling device for retrieval, in which a stored item is adapted to be transferred to the load-handling device for storage or in which a stored item is discharged from the load-handling device for retrieval, and a second rotational position corresponding to the angle (α), in which the load-handling device introduces a stored item into one of the storage locations or discharges the stored item from one of the storage locations.

8. The conveying device according to claim 1, wherein the load-handling device is mounted in a rotationally fixed manner at the angle (α) with respect to the direction of travel.

9. The conveying device according to claim 1, wherein a lifting unit is provided, which is adjustable vertically with respect to the direction of travel in and against a lifting direction, wherein the load-handling device is receivable by the lifting unit, and wherein the load-handling device is set up to introduce stored goods into one of the storage locations essentially vertically with respect to the lifting direction or to remove them from one of the storage locations.

10. The conveying device according to claim 1, wherein the load-handling device, formed as a vehicle, which is set up to enter a storage channel of one of the storage locations or to leave a storage channel of one of the storage locations.

11. A rack storage system comprising:
at least one rack that comprises at least two storage locations; and
a rack aisle that extends at least in sections along the rack and in which at least one conveying device according to claim 1 is arranged and formed as a stacker crane.

12. The rack storage system according to claim 11, wherein the storage locations are designed such that a load-handling device enters them in alignment or leaves them in alignment.

13. The rack storage system according to claim 11, wherein the storage locations essentially span a parallelogram as seen in a direction of fall, which differs from a rectangle.

14. The rack storage system according to claim 11, wherein at least one transfer zone is provided, which extends through at least one of the shelves in order to transfer a stored item to be stored to the conveying device for storage or to output a stored item to be retrieved from the conveying device for retrieval.

15. The rack storage system according to claim 11, wherein a receiving area serving for storage is provided on a side of a first shelf facing away from the shelf aisle, and wherein a dispensing area serving for retrieval is provided on a side of a second shelf facing away from the shelf aisle, and wherein the first shelf and the second shelf are arranged on both sides of the shelf aisle and form the shelf aisle between them.
